(19) United States
(12) Patent Application Publication
(10) Pub. No.: US 2026/0349787 A1
(43) Pub. Date: Nov. 5, 2026

(54) HYBRID SCHEDULING FOR OUT-OF-ORDER PROCESSING

(71) Applicant: GOOGLE LLC, Mountain View, CA (US)

(72) Inventors: Nishant Panigrahi, San Jose, CA (US); Shivam Priyadarshi, San Jose, CA (US); Vidisha Reddy Chirra, Austin, TX (US); James Joseph Bonanno, Liberty Hill, TX (US); Dung Quoc Nguyen, Austin, TX (US); John Esper, Austin, TX (US)

(21) Appl. No.: 19/197,449

(22) Filed: May 2, 2025

(51) Int. Cl. G06F 9/48

(52) U.S. Cl. CPC G06F 9/4881

(57) ABSTRACT

A processor including reservation stations configured to schedule the execution of instructions of a program is disclosed. The reservations stations may receive instructions from the program based on their type. A first type of reservation station may receive instructions that are processed most efficiently using a dispatch and pick approach that maximizes the capacity of segments in the reservation station. A second type of reservation station receives instructions that are processed most efficiently using a dispatch and pick approach that preserves the program order of the instructions. The reservation stations operate together to provide a hybrid scheduling of the instructions, which can improve processing efficiency.

### FIELD OF THE DISCLOSURE

The present disclosure relates to a central processing unit (CPU) core and more specifically to a superscalar processor that implements instruction-level parallelism.

### BACKGROUND

Instruction-level parallelism (ILP) includes executing instructions of a program not in the original order of the program. For example, instructions, which are not dependent on each other, can be executed out of their program order. The parallelism that results from out-of-order processing can reduce the time the processor spends waiting for instructions to be completed and can increase the number of instructions that can be executed per clock cycle.

### SUMMARY

Some types of instructions benefit from the parallelism resulting from out-of-order processing. For these types, a scheduling that maximizes the number of instructions that are scheduled at one time (i.e., capacity-based scheduling) offers performance benefits because more opportunities for out-of-order processing may be identified. Other types of instructions, however, actually benefit more from a scheduling that preserves the program order of instructions (i.e. order-based scheduling). The present disclosure describes a processor that includes reservation stations configured for capacity-based scheduling and order-based scheduling to maximize performance.

In some aspects, the techniques described herein relate to a method for executing a program using a processor, the method including: receiving an instruction from the program; decoding the instruction to determine a type of the instruction; determining that the type is sensitive to an order of execution; allocating the instruction to an order-based reservation station of the processor, the order-based reservation station having a plurality of segments; dispatching the instruction to a segment of the plurality of segments according to an order-based dispatch policy of the order-based reservation station; issuing the instruction to an execution unit coupled to the order-based reservation station according to an order-based pick policy of the order-based reservation station; and executing the instruction using the execution unit.

In some aspects, the techniques described herein relate to a processor including: a decode module configured to receive instructions of a program in a program order and determine respective types of the instructions; and an allocation module configured to allocate a first portion of the instructions of a first type to an order-based reservation station and a second portion of the instructions of a second type to a capacity-based reservation station, wherein: the order-based reservation station is configured to store the first portion of the instructions in segments of the order-based reservation station according to an order-based dispatch policy, which preserves the program order of the first portion of the instructions; and the capacity-based reservation station is configured to store the second portion of the instructions in segments of the capacity-based reservation station according to a capacity-based dispatch policy, which does not preserve the program order of the second portion of the instructions.

In some aspects, the techniques described herein relate to a processor, including: an order-based reservation station configured to receive instructions of a first type from a program, the first type being sensitive to an order of execution, the order-based reservation station including: a first dispatch module configured to store instructions in segments of the order-based reservation station according to an order-based dispatch policy so that the segments of the order-based reservation station receive instructions based on a program order of the instructions; and a capacity-based reservation station configured to receive instructions of a second type from the program, the second type being sensitive to a capacity of segments of the capacity-based reservation station, the capacity-based reservation station including: a second dispatch module configured to store instructions in segments of the capacity-based reservation station according to a capacity-based dispatch policy so that the segments of the capacity-based reservation station receive instructions based on a segment vacancy regardless of the program order of the instructions.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a system diagram illustrating a portion of a CPU core configured for out-of-order processing according to a possible implementation of the present disclosure.

FIG. 2A illustrates a scheduling bottleneck caused by a reservation station that is too small.

FIG. 2B illustrates an issuing bottleneck caused by a reservation station that is too large.

FIG. 2C illustrates a reservation station with multiple segments to mitigate the scheduling bottleneck and the issuing bottleneck of FIGS. 2A and 2B according to a possible implementation of the present disclosure.

FIG. 3 illustrates reservation stations configured for scheduling different types of instructions according to a possible implementation of the present disclosure.

FIG. 4 is a flowchart of a method for executing a program using hybrid scheduling according to a possible implementation of the present disclosure.

FIG. 5 is a flowchart of a method for a capacity-based dispatch in a reservation station according to a possible implementation of the present disclosure.

FIG. 6 illustrates the method for capacity-based dispatch of FIG. 5 according to a possible implementation of the present disclosure.

FIG. 7 is a flowchart of a method for a capacity-based pick in a reservation station according to a possible implementation of the present disclosure.

FIG. 8 illustrates the method for capacity-based pick of FIG. 7 according to a possible implementation of the present disclosure.

FIG. 9 is a flowchart of a method for an order-based dispatch in a reservation station according to a possible implementation of the present disclosure.

FIG. 10 illustrates the method for order-based dispatch of FIG. 9 according to a possible implementation of the present disclosure.

FIG. 11 is a flowchart of a method for an order-based pick in a reservation station according to a possible implementation of the present disclosure.

FIG. 12 illustrates the method for order-based pick of FIG. 11 according to a possible implementation of the present disclosure.

The components in the drawings are not necessarily to scale relative to each other. Like reference numerals designate corresponding parts throughout the several views.

### DETAILED DESCRIPTION

Out-of-order processing requires scheduling the execution of instructions from a program. To carry this out, a CPU core (i.e., processor) may include a plurality of reservation stations for scheduling instructions of different types (e.g., integer, floating point, branch, memory, etc.). Each reservation station is configured to receive and store instructions of a particular type until they are ready to be executed by a respective execution unit. Larger reservation stations can store and schedule more instructions. As a result, the processor is able to improve the ability to execute instructions in parallel. The ultimate size of a reservation station may be limited, however, because one large reservation station may require more time to issue stored instructions. Accordingly, a larger reservation station may be subdivided (i.e., segmented) into multiple reservation station segments. The segmented reservation station can expand the number of instructions that can be handled (i.e. the capacity of the reservation station) without adding a pipeline delay associated with issuing stored instructions from one large reservation station.

One technical problem with using multiple segments is that it can lead to inefficiencies in how the instructions are stored or in how the instructions are issued. One reason for this is that, without added logic and communication, there is no way to determine the relative ages of instructions stored in different segments. For example, the program order (i.e. order) of the instructions may be lost when the instructions are dispatched between segments to maximize segment occupancy (i.e. capacity). On the other hand, preserving the order of stored instructions in segments may require a segment to be fully depleted before it can be refilled, which does not maximize segment occupancy (i.e., capacity). In other words, order information can be maximized at the expense of capacity efficiency, and capacity efficiency can be maximized at the expense of order information. One technical problem is how to resolve this tradeoff. Notably, some instruction types benefit from a scheduling that maximizes capacity while other instruction types benefit from a scheduling that preserves order.

The present disclosure describes a hybrid scheduling approach that first determines a type of the instructions and uses an order-based reservation station for instructions that are sensitive to the order of their execution (i.e., order-based instructions). Correspondingly, the hybrid scheduling approach may use a capacity-based reservation station for instructions that are not sensitive to their order of execution (i.e., capacity-based instructions). A technical effect of this scheduling-by-type approach is that the overall rate of instruction execution can be improved, thereby increasing the performance of the processor.

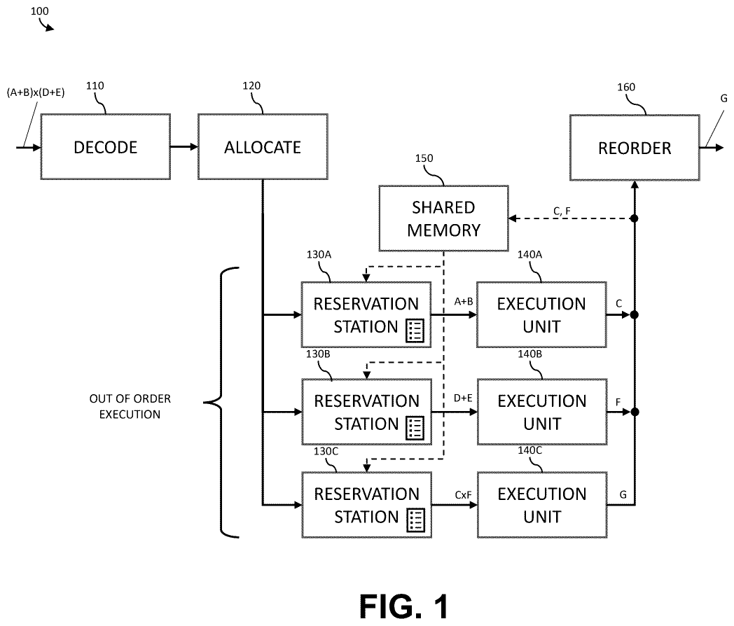

FIG. 1 is a system diagram illustrating a portion of a CPU core (i.e., processor 100) configured for out-of-order processing according to a possible implementation of the present disclosure. The processor 100 includes a decode module 110 configured to receive instructions from a program running on the processor 100. The instructions may be received in a program order from oldest to youngest. In other words, a first instruction may be received followed by a second instruction. In this case, the second instruction is younger, in the program order, than the first instruction.

The decode module 110 is further configured to determine the types (and dependencies) and program order of the instructions. The decode module may assign a type to an instruction based on the resources that the instruction needs for execution. For example, an instruction requiring an arithmetic logic unit (ALU) configured to output a result in a floating-point format may be typed as a floating-point instruction (i.e. FP). Likewise, an instruction requiring an ALU configured to output a result in an integer format may be typed as an integer instruction (i.e., INT). An instruction requiring access to a memory may be typed as a memory instruction. An instruction that points to a branch of instructions in the program for execution based on a result of the instruction (e.g., IF x THEN y ELSE z) may be typed as a branch instruction (e.g., bidirectional conditional branch instruction).

The instructions and their types are transmitted to an allocation module 120. The allocation module 120 is configured to transmit each instruction to one reservation station of a plurality of reservation stations based on the type of each instruction. Three reservation stations are illustrated in FIG. 1, but the processor 100 may include more or less reservation stations in various implementations. A first reservation station 130A is configured to schedule instructions of a first type for execution by a first execution unit 140A; a second reservation station 130B is configured to schedule instructions of a second type for execution by a second execution unit 140B; and a third reservation station 130C is configured to schedule instructions of a third type for execution by a third execution unit 140C. The execution units may execute instructions out of their program order and during the same clock cycle (i.e., in parallel), which can optimize the rate at which the instructions are performed.

After execution, the results may be out of a program order. Accordingly, the processor 100 further includes a reorder module 160 configured to reorder the results according to the program. The processor 100 further includes a shared memory 150 (e.g., a register file type memory including flops and latches) that can store the results. The shared memory may be accessed by the reservation station for scheduling. For example, an instruction at a reservation station may require other instructions to be completed before it is ready for execution. A reservation station may monitor the shared memory 150 to determine when an instruction is ready for execution.

A program may include instructions to compute equation, (A+B)·(D+E). In response, an allocation module 120 (and/or dispatch module) may identify that the instructions (A+B) and (D+E) may be executed out of order. Accordingly, the instruction (A+B) may be allocated to the first reservation station 130A where it can be executed to produce the intermediate result C. At the same time, the instruction (D+E) may be sent to the second reservation station 130B. The intermediate result, C, may be stored in the shared memory 150 until a second intermediate result F is ready. When ready, the third reservation station 130C and the third execution unit 140C may compute the final result G, which is output by the reorder module 160.

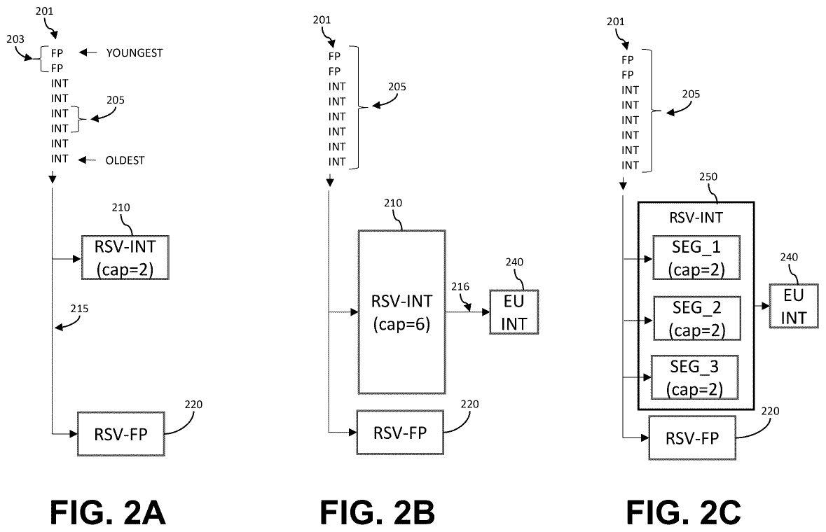

The processor 100 of FIG. 1 may have a variety of inefficiencies, which are best illustrated by example configurations shown in FIGS. 2A-2C. The illustrations are hypothetical and presented for understanding and are not intended to be limiting.

FIG. 2A illustrates a bottleneck delay caused by a reservation station that is too small. As shown, multiple reservation stations include a first reservation station 210 configured to schedule integer instructions (INT) of a sequence of instructions (i.e. workload 201) and a second reservation station 220 configured to schedule floating point instructions (FP) of the workload 201. The first reservation station 210 has a small capacity (e.g., 2), which creates an out-of-order window 205 that is too small to consider (i.e., see) the two floating point instructions 203 of the workload 201 until some of the integer instructions have been executed. In other words, while the two floating point instructions 203 could be executed out-of-order, they are not scheduled until the older integer instructions have been executed. The limited capacity of the first reservation station 210 creates a scheduling bottleneck 215 (i.e. scheduling delay) in the flow of floating-point instructions to the second reservation station 220. The scheduling bottleneck 215 can leave the second reservation station empty, which reduces the efficiency of the out-of-order processing.

FIG. 2B illustrates a reservation station having a pipeline delay that limits throughput according to a possible implementation of the present disclosure. To alleviate the scheduling bottleneck 215, the first reservation station 210 may be configured to have a larger capacity (e.g., 6), which expands (i.e. increases) the out-of-order window 205 so that all the instructions of the workload 201 can be scheduled at approximately the same time. Increasing the capacity of the first reservation station 210, however, can increase the amount of time taken for an instruction stored in the first reservation station 210 to be issued to the corresponding execution unit 240. The increased time may correspond to a propagation delay associated with the larger physical size of the first reservation station 210. Because the instructions are issued in a pipeline, the delay associated with the slowest issued instruction can limit the issue time of all other instructions in the pipeline. The longer issue time can create an issuing bottleneck 216 (i.e., issuing delay), which can reduce the rate at which instructions can be executed.

FIG. 2C illustrates a reservation station with multiple segments to mitigate the scheduling bottleneck 215 and the issuing bottleneck 216 of FIGS. 2A and 2B according to a possible implementation of the present disclosure. The first reservation station 250 is configured to have a plurality of segments (SEG_1, SEG_2, SEG_3), which provides the first reservation station 250 with the larger capacity (e.g., 6) consisting of multiple smaller capacity (e.g., 2) segments. The larger capacity reduces the scheduling bottleneck 215 (e.g., compared to FIG. 2A), and the smaller physical size of each segment reduces the issuing bottleneck 216 (e.g., compared to FIG. 2B).

The segmented reservation station may include a dispatch module configured to route each received instruction to a particular segment based on a dispatch scheduling policy. In a possible implementation, the dispatch scheduling policy includes filling a vacancy of any segment with an instruction regardless of the order of the instruction in the workload 201. This approach can maximize the capacities of the segments but does not preserve the order of the instructions within a segment (or between segments). Without added communication between the segments, it may be impossible to determine the relative order of the instructions between segments. As a result, instructions which include dependencies may be slowed while waiting for intermediate results scheduled in different segments. For example, scheduling a series of dependent instructions (A→B→C) using different segments may make out-of-order processing inefficient because each segment may have its own rate and order at which instructions are processed. As a result, added scheduling, logic, and/or time may be required to determine the results of the dependent instructions. Accordingly, preserving an approximate program order of instructions in a segment (and between segments), may increase an overall rate of the processing for some types of instructions (and workloads).

Another possible inefficiency, which the processor 100 of FIG. 1 may experience, results from instructions related to a branch point in the flow of a program. For example, control flow instructions in a program, such as “IF x, THEN y, ELSE z”, may result in two possible outcomes (y, z) based on an input (x). After the control-flow instruction (i.e., branch instruction), the program may proceed with instructions of a first branch or instructions of a second branch. Each set of instructions may include subsequent branch instructions. Branches can be bi-directional or multi-directional. For example, a menu may result in a multi-directional branch having a plurality of possible paths based on an input (e.g., a user input).

When the processor executes instructions out of order, some subsequent branch instructions may be ready for execution before knowing which branch is valid. In this case, the processor may estimate (e.g., based on patterns and/or previous histories) the more likely branch and begin to speculatively execute instructions of this branch. If it later turns out that this estimation was incorrect, then the processor must discard this work and begin to correctly execute instructions of the other branch. This scenario can result in wasted power and reduced performance. Scheduling based on the program order of the instructions can help to prevent the negative results resulting from branch instructions.

Another possible inefficiency, which the processor 100 of FIG. 1 may experience, results from instructions related to accessing a memory. Memory access may be required to be in order to prevent errors. For example, a program flow may require the following instructions: WRITE(1) to memory block_A, READ(1) from memory block_A, WRITE(2) to memory block_A. If the instructions are performed out of order (e.g., READ(1) instruction is performed after the WRITE(2) instruction), then the program may read the wrong results. If this error is detected, then the processor must discard all work from the incorrect read results and redo the write operation to update the memory correctly. This scenario results in wasted power and reduced performance. Scheduling based on the program order of the instructions can help to prevent these negative results resulting from memory access instructions (i.e., memory instructions).

The disclosed approach uses multiple segmented reservation stations to implement a hybrid scheduling approach, which can improve the performance of a processor. The processor can include a first (segmented) reservation station configured to preserve order information for the portion of instructions that can be executed most efficiently when the order is preserved and using a second (segmented) reservation station configured to maximize capacity for the portion of instructions that can be executed most efficiently in any order.

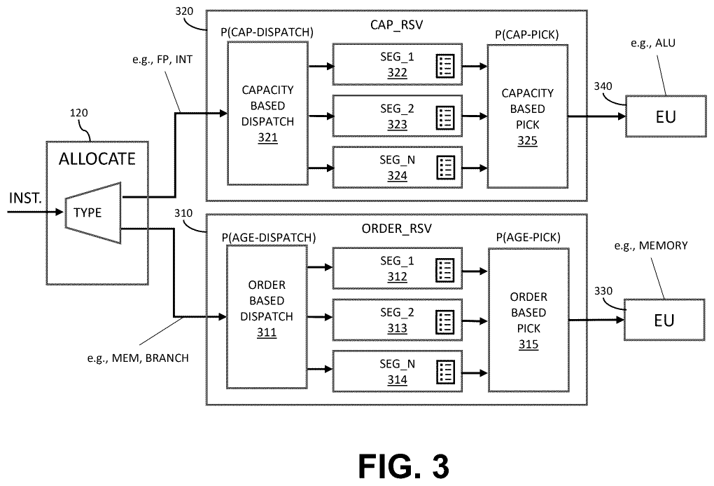

FIG. 3 illustrates reservation stations configured for scheduling different types of instructions according to a possible implementation of the present disclosure. As shown, a sequence of instructions may be transmitted to an allocation module 120. The allocation module 120 can be configured to transmit (e.g., route) a first portion of the instructions (i.e., instructions of the first type) to the order-based reservation station 310 and transmit (e.g., route) a second portion of the instructions (i.e., instructions of the second type) to the capacity-based reservation station 320. The order-based reservation station 310 is configured to store the first portion of the instruction in segments 312, 313, 314 of the order-based reservation station 310, and the capacity-based reservation station 320 is configured to store the second portion of the instructions in segments 322, 323, 324 of the capacity-based reservation station 320. The order-based reservation station 310 and the capacity-based reservation station 320 may have different policies for how the instructions are stored (i.e., scheduled).

The first type of instruction allocated to the order-based reservation station 310 may be sensitive to an order of execution. In other words, the rate at which instructions of the first type can be executed can be increased when executed in the order of the program (i.e., program order). In a possible implementation, the first type may be a memory instruction and the execution unit 330 coupled to the order-based reservation station 310 may be configured to access a memory according to the memory instruction. In another possible implementation, the first type may be a branch instruction and the execution unit 330 coupled to the order-based reservation station 310 may be configured to execute a branch of the program according to the branch instruction.

The second type of instruction allocated to the capacity-based reservation station 320 may be sensitive to the capacity of the segments. In other words, the rate at which instructions of the second type can be executed can be increased when the segments 322, 323, 324 are all at (or near) full capacity. In a possible implementation, the second type may be an integer instruction, and the execution unit 340, coupled to the capacity-based reservation station 320, may be an arithmetic logic unit configured for integer operations. In another possible implementation, the second type may be a floating-point instruction, and the execution unit 340, coupled to the capacity-based reservation station 320, may be an arithmetic logic unit configured for floating-point operations.

The first portion of the instructions may be received at the order-based reservation station 310 in a program order from oldest (i.e. first or earlier arriving) to youngest (i.e., last or later arriving). The order-based reservation station 310 includes an order-based dispatch module 311 that is configured to store the first portion of the instructions in segments 312, 313, 314 according to an order-based dispatch policy (i.e., P(AGE-DISPATCH)). The order-based dispatch policy is configured to preserve the program order of the first portion of the instructions. The program order provided by the order-based dispatch policy may be an approximate program order, which is not an exact replica of the program order. The approximate program order provided by the order-based dispatch module 311 may be an approximation (e.g., within a few instructions) of the original program order, which increases the rate of execution compared to a rate of execution in random order.

The second portion of the instructions may be received at the capacity-based reservation station 320 in a program order from oldest (i.e. first or earlier arriving) to youngest (i.e., last or later arriving). The capacity-based reservation station 320 includes a capacity-based dispatch module 321 that is configured to store the second portion of the instructions in segments 322, 323, 324 according to a capacity-based dispatch policy (i.e., P(CAP-DISPATCH)). The capacity-based dispatch policy is configured to store the instructions based on segment vacancy and does not preserve the program order of the first portion of the instructions.

Each segment in a reservation station may be configured to store a plurality of instructions until they are ready for execution. The readiness for execution may be based on a variety of scheduling factors including (but not limited to) the age of the instruction within the segment and the readiness of results necessary for executing the instruction. When ready, an instruction from a segment may be picked from the segment and transmitted to the corresponding execution unit (EU) according to an issue policy. The order-based reservation station 310 and the capacity-based reservation station 320 may have different issue policies.

The order-based reservation station 310 includes an order-based pick module 315 that is configured to issue the first portion of the instructions in segments 312, 313, 314 according to an order-based issue policy (i.e., P(AGE-PICK)). The order-based issue policy is configured to preserve an approximate program order of the first portion of the instructions.

The capacity-based reservation station 320 includes a capacity-based pick module 325 that is configured to issue the first portion of the instructions in segments 322, 323, 324 according to a capacity-based issue policy (i.e., P(CAP-PICK)). The capacity-based issue policy is configured to issue instructions based on readiness and does not preserve an approximate program order of the first portion of the instructions.

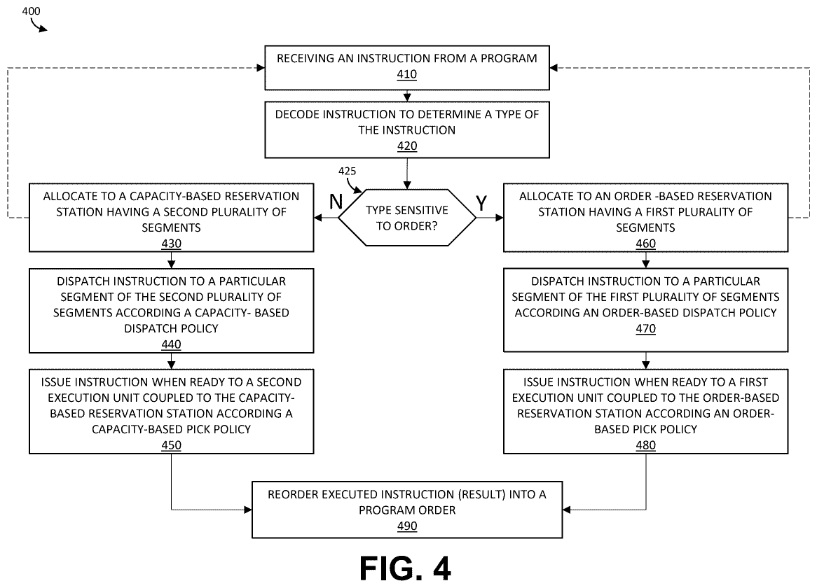

FIG. 4 is a flowchart of a method for executing a program using hybrid scheduling according to a possible implementation of the present disclosure. The method includes receiving 410 an instruction from a program. An instruction may be an operation performed to carry out the program. For example, the instruction may be a logical comparison, a mathematical operation, memory access instruction, or a conditional evaluation. The instruction may be included in a sequence of instructions received in a program order. Younger instructions in the sequence are instructions that are received after older instructions in the sequence.

The method 400 may further include decoding 420 the instruction to determine its type. The type of the instruction may correspond to the execution unit necessary for carrying out the instruction. For example, an instruction may be decoded to determine that it is a mathematical operation that requires a floating-point calculation. Accordingly, the type of instruction may be determined as floating point.

The method 400 further includes determining 425 if the type is sensitive to an order of execution (Y) or not sensitive to an order of execution (N). In other words, some types of instructions may benefit from a scheduling that uses the order in which an instruction was received, while other types of instructions may not have any benefit from scheduling based on the order information.

When the instruction is a first type that is sensitive to the order of execution, the method 400 includes allocating 460 the instruction to an order-based reservation station of the processor. The order-based reservation station has a plurality of segments. The method 400 further includes dispatching 470 the instruction to a segment of the plurality of segments according to an order-based dispatch policy. The dispatched instruction may be stored in the segment until it is ready for execution. The method 400 further includes issuing 480 the (ready) instruction to an execution unit coupled to the order-based reservation station according to an order-based pick policy. The execution unit can then execute the issued instruction. The method 400 further includes reordering 490 the executed instruction (i.e., result) with other executed instructions so that the results are in an order that corresponds to the program order.

When the instruction is a second type that is not sensitive to the order of execution, the method 400 includes allocating 430 the instruction to a capacity-based reservation station of the processor. The capacity-based reservation station has a plurality of segments. The method 400 further includes dispatching 440 the instruction to a segment of the plurality of segments according to a capacity-based dispatch policy. The dispatched instruction may be stored in the segment until it is ready for execution. The method 400 further includes issuing 450 the (ready) instruction to an execution unit coupled to the capacity-based reservation station according to a capacity-based pick policy. The execution unit can then execute the issued instruction. The method 400 further includes reordering 490 the executed instruction and other executed instructions into an order that corresponds to a program order.

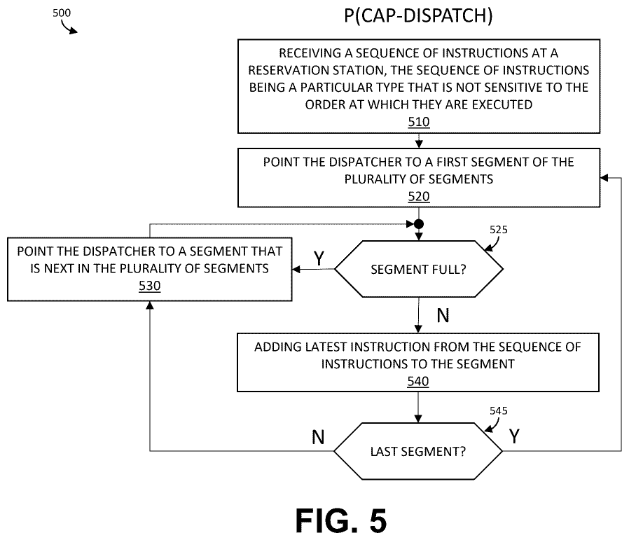

FIG. 5 is a flowchart of a method for a capacity-based dispatch in a reservation station according to a possible implementation of the present disclosure. The method 500 may correspond to the capacity-based dispatch policy (i.e., P(CAP-DISPATCH)) of the capacity-based reservation station 320. The capacity-based reservation station includes a plurality of segments arranged logically in a sequential order. The method 500 includes receiving 510 a sequence of instructions in a program order. The method 500 further includes addressing each segment of the plurality of segments according to a segment-by-segment rotation (i.e. round-robin rotation) through the sequential order of the segments and writing the instructions one-by-one in the program order to each segment having a vacancy.

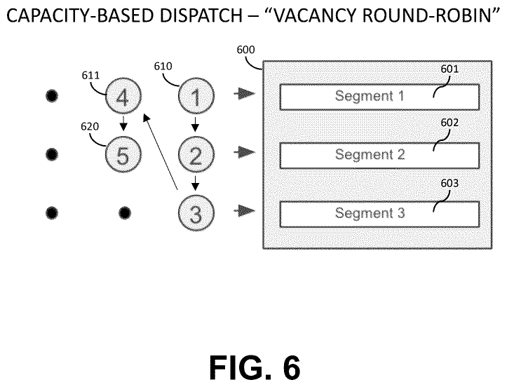

As shown in FIG. 5, the method 500 may include pointing 520 a capacity-based dispatch module (i.e., dispatcher) to a first segment of the plurality of segments. Determining 525 if the segment is full (Y) or not full (N). When the segment is full, then the method 500 includes pointing 530 the dispatcher to a segment that is next in the sequence of segments (i.e., the next segment), otherwise the method 500 includes adding 540 (i.e., writing) the latest (i.e. oldest) instruction of the received instructions to the segment and then pointing the dispatcher to the next segment. If the segment receiving the instruction is the last segment 545 in the sequence of segments, then the method 500 points to the dispatcher to the first segment of the plurality of segments, otherwise the dispatcher points to the next segment (higher) in the sequence. As before, it is determined if the next segment has a vacancy, and if so, the dispatcher writes the latest unrecorded instruction of the sequence to the next segment. The method 500 for the capacity-based dispatch is visually illustrated in FIG. 6.

FIG. 6 illustrates the method for capacity-based dispatch of FIG. 5 according to a possible implementation of the present disclosure. As shown, a capacity-based reservation station 600 includes a first segment 601, a second segment 602, and a third segment 603 arranged in a sequence of segments. The reservation station receives a sequence of instructions (e.g., 1, 2, 3, 4, 5) from an oldest instruction 610 to a youngest instruction 620. The instructions are dispatched (i.e., written) in order to segments capable of receiving an instruction (i.e., having a vacancy). Accordingly, the dispatcher moves (i.e., points) from segment-to-segment in a repeating sequence (e.g., segment1, segment2, segment3, segment1, segment2, etc.).

As shown in FIG. 6, initially the capacity-based dispatch module (i.e., dispatcher) points to the first segment 601 and determines that the first segment 601 can store an instruction (i.e., has a vacancy). As a result, the oldest instruction 610 is written to the first segment 601. The dispatcher then moves to the next segment in the sequence (i.e., second segment 602) and determines that the second segment 602 has a vacancy. As a result, the next oldest instruction (i.e., 2) is written to the second segment 602. The dispatcher then moves to the next segment in the sequence (i.e., third segment 603) and determines that the third segment 603 has a vacancy. As a result, the next oldest instruction (i.e., 3) is written to the third segment 603. This, being the last segment, triggers the dispatcher to point (again) to the first segment 601 and the process is repeated. This form of capacity-based dispatch may be referred to as vacancy round-robin because the dispatcher moves in round robin fashion recording instructions in segments based on their vacancy status. When a segment has no vacancy the dispatcher may skip the segment. Dispatching instructions in this way can maximize the occupancy of the segments but does not preserve the program order of the instructions stored in each segment and does not preserve a program order of instructions between segments. For example, the oldest instruction 610 (i.e., 1) stored in segment 1 is followed by the second youngest instruction 611 (i.e. 4).

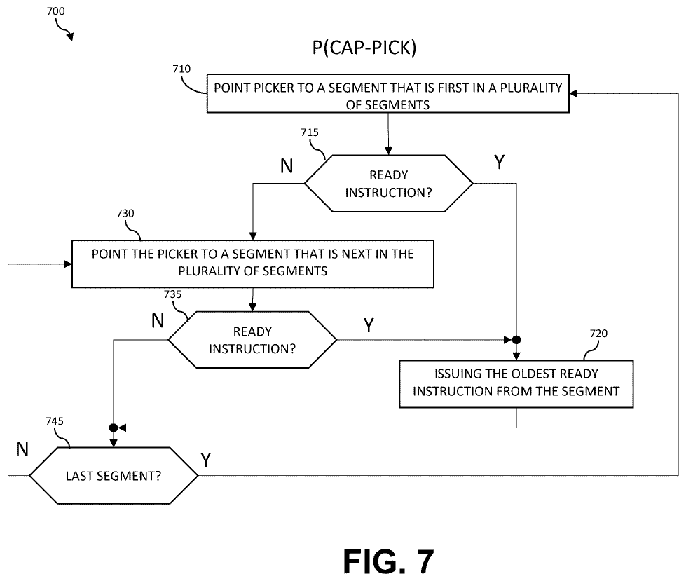

FIG. 7 is a flowchart of a method for a capacity-based pick in a reservation station according to a possible implementation of the present disclosure. The method 500 may correspond to the capacity-based pick policy (i.e., P(CAP-PICK)) of the capacity-based reservation station 320. The capacity-based pick policy includes issuing an oldest and ready (i.e., oldest-ready) instruction from each segment having at least one instruction ready to be picked in a segment-by-segment rotation through the plurality of segments.

As shown in FIG. 7, the method 700 includes pointing 710 a capacity-based pick module (i.e., picker) to a segment that is first in a plurality of segments and determining 715 if there is a ready instruction in the first segment (Y) or if there is no instruction ready (for issue) in the first segment (N). When there is a ready instruction (or multiple ready instructions), then the method 700 includes issuing 720 the oldest ready instruction from the first segment. After the instruction is issued, the method 700 includes pointing 730 the picker to the next segment in the sequence of segments determining 735 if there is a ready instruction in the next segment. If so, the oldest-ready instruction of the next segment is issued, otherwise the next segment is skipped and the pointer (i.e. picker) moves to the next higher segment in the sequence. When the pointer reaches the last segment 745, then the pointer moves back to the first segment, and the method continues.

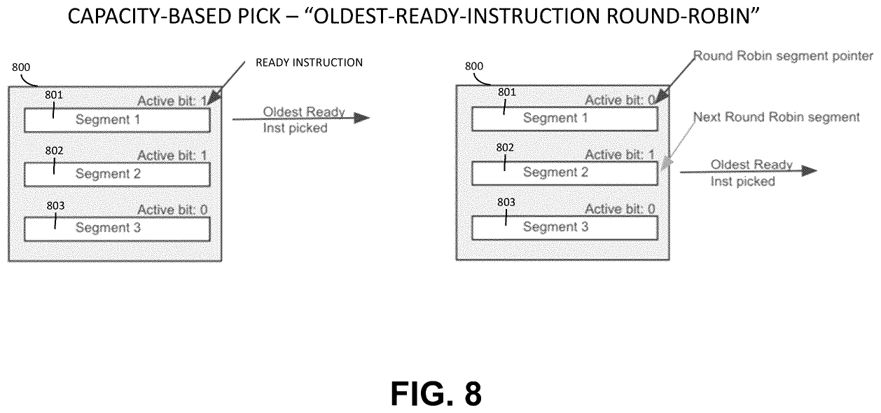

FIG. 8 illustrates the method for capacity-based pick of FIG. 7 according to a possible implementation of the present disclosure. As shown, a capacity-based reservation station 800 includes a first segment 801 (i.e., segment1), a second segment 802 (i.e., segment2), and a third segment 803 (i.e., segment3 ). Each segment can include a plurality of instructions from an oldest instruction to a youngest instruction. Each segment may be addressed (i.e. pointed to) segment-by-segment in cyclical rotation (i.e., round robin) through the plurality of segments (e.g., segment1, segment2, segment3, segment1, segment2, segment3, etc.). When addressed, the oldest and ready (i.e., oldest-ready) instruction may be picked for issue from the segment. When no instruction in a segment being addressed is ready to be picked, then the segment is skipped without picking any instruction for issue. This form of capacity-based pick may be referred to as the oldest-ready-instruction round-robin because the dispatcher picks ready instructions from segments in round robin fashion.

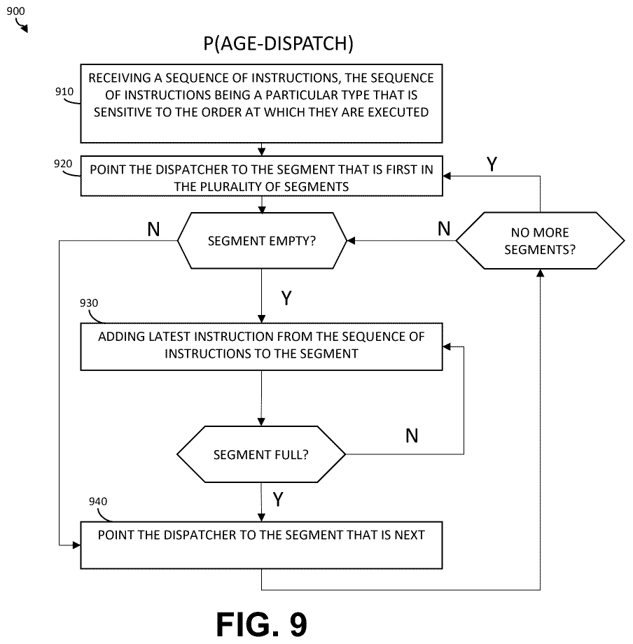

FIG. 9 is a flowchart of a method for an order-based dispatch in a reservation station according to a possible implementation of the present disclosure. The method 900 may correspond to the order-based dispatch policy (i.e., P(AGE-DISPATCH)) of the order-based reservation station 310. The order-based reservation station includes a plurality of segments arranged logically in a sequential order. The order-based dispatch policy includes receiving a sequence of instructions in a program order at the order-based reservation segment. The order-based dispatch policy further includes dispatching the instructions, in their program order, to an empty segment until the empty segment is filled with instructions (i.e., has no vacancy).

As shown, the method 900 includes receiving 910 a sequence of instructions at an order-based reservation station. The instructions of the sequence are of a particular type that are executed most efficiently in a program order (i.e., sensitive to program order). The method 900 further includes pointing 920 an order-based dispatch module (i.e., dispatcher) to a segment (e.g., first segment). The method 900 further includes adding 930 (i.e., writing) the latest (i.e. oldest) instruction from the sequence of instructions to the segment when the segment is empty. The method 900 further includes continuing to add instructions (in the program order) to the segment until the segment is full. After writing the instructions to the segment, the method 900 further includes pointing 940 the dispatcher to the next segment in the sequence of segments, which is empty, and filling the segment with instruction (in order).

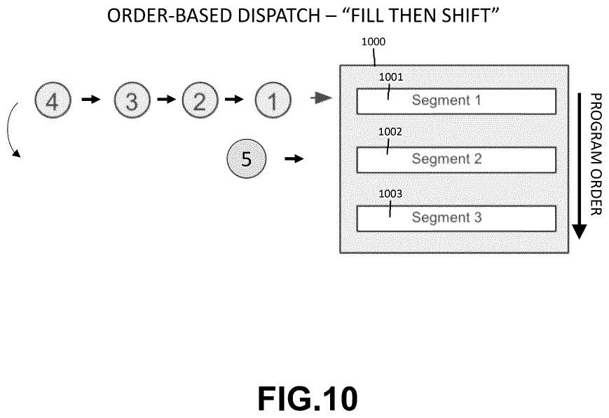

FIG. 10 illustrates the method for order-based dispatch of FIG. 9 according to a possible implementation of the present disclosure. As shown, an order-based reservation station 1000 includes a first segment 1001, a second segment 1002, and a third segment 1003 arranged in a sequence of segments. As shown, upon determining that first segment 1001 is empty, instructions (e.g., 1, 2, 3, 4) are dispatched to the first segment 1001 in their program order until the segment has been filled. The segment is configured to store the set of instructions in their program order. Instructions may be dispatched to fill segments in sequence until all the segments are filled. A segment is not refilled until all the instructions in the segment have been issued. In other words, only empty segments are filled. When initially filled, the first segment 1001, the second segment 1002, and the third segment 1003 reflect the program order with the first segment 1001 being the oldest in the program order. As instructions are issued, the program order of the sequence of segments may shift. In a possible implementation, the relative orders of the segments may be monitored with a pointer directed at the segment currently storing the oldest instructions of the program. Dispatching only to empty segments does not maximize the occupancy (capacity) of the segments. The order-based dispatch may be referred to as a fill then shift policy because it fills each segment with instructions in their program order before shifting to the next (empty) segment. This dispatching guarantees that the instructions can be picked in an approximate program order.

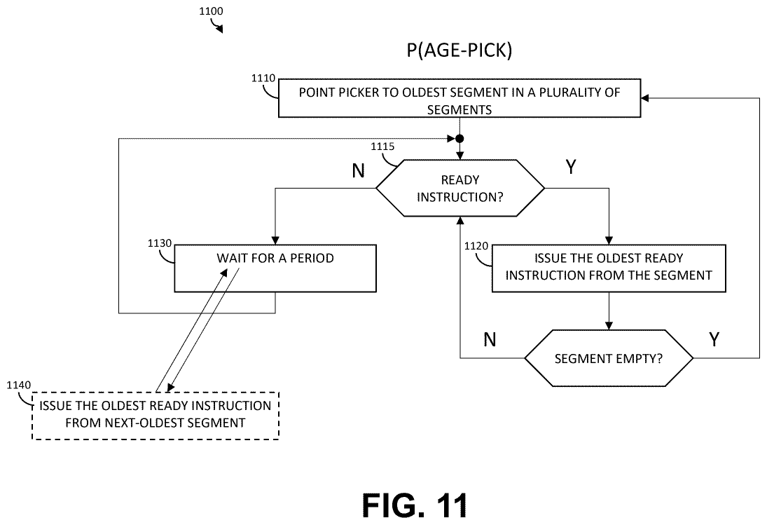

FIG. 11 is a flowchart of a method for an order-based pick in a reservation station according to a possible implementation of the present disclosure. The method 500 may correspond to the order-based pick policy (i.e., P(AGE-PICK)) of the order-based reservation station 310. The method 1100 includes identifying an oldest segment of a plurality of segments by pointing 1110 an order-based pick module (i.e., picker) to the oldest segment. The method 1100 further includes determining 1115 if the oldest segment has an instruction ready to be picked (i.e., ready instruction). The method 1100 further includes issuing 1120 the oldest and ready instruction (i.e., oldest-ready instruction) from the oldest segment to an execution unit when the oldest segment has a ready instruction. When there is no ready instruction in the oldest segment the method 1100 may further include waiting 1130 for a period before trying again to identify and issue an oldest-ready instruction from the oldest segment.

In a possible implementation, waiting 1130 for the period (i.e., waiting period) includes identifying the next-oldest segment and issuing 1140 the oldest-ready instruction of the next-oldest segment to the execution unit before trying again to identify and issue the oldest-ready instruction from the oldest segment.

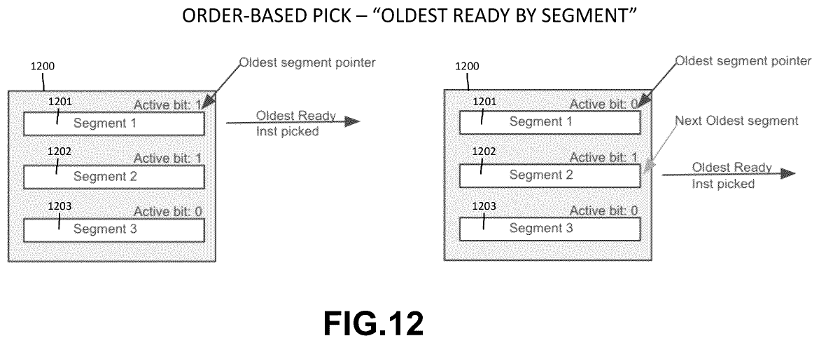

FIG. 12 illustrates the method for order-based pick of FIG. 11 according to a possible implementation of the present disclosure. As shown, an order-based reservation station 1200 includes a first segment 1201, a second segment 1202, and a third segment 1203 arranged in a sequence of segments. As shown, an oldest segment pointer may be used to indicate the oldest segment is the first segment 1201. The picker may analyze the instructions in the oldest segment to determine their relative age and their readiness for issue. If multiple ready instructions are determined, then the picker picks the oldest of the ready instructions for issue to an execution unit. In some cases, the oldest ready instruction will not be the absolute oldest instruction of the segment. Accordingly, the issued instructions may not be issued in an approximate program order. The approximate program order may still offer more benefits to the rate at which the instructions can be executed compared to a round robin picking approach (e.g., see FIG. 8). In some cases, there is no ready instruction in the oldest segment. In this case, the picker may wait for a period to for a ready instruction to appear. In a possible implementation, this period may be used to pick an oldest ready instruction (if available) from the next oldest segment. Accordingly, the issued instruction may further approximate the program order but the approximation may still offer some benefit compared to an approach that does not take any measures to preserve order.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

1. A method for executing a program using a processor, the method comprising:
receiving an instruction from the program;
decoding the instruction to determine a type of the instruction;
determining that the type is sensitive to an order of execution;
allocating the instruction to an order-based reservation station of the processor, the order-based reservation station having a plurality of segments;
dispatching the instruction to a segment of the plurality of segments according to an order-based dispatch policy of the order-based reservation station;
issuing the instruction to an execution unit coupled to the order-based reservation station according to an order-based pick policy of the order-based reservation station; and
executing the instruction using the execution unit.

2. The method for executing the program using the processor according to claim 1, wherein:
the type is a memory instruction; and
the execution unit is configured to access a memory according to the memory instruction.

3. The method for executing the program using the processor according to claim 1, wherein:
the type is a branch instruction; and
the execution unit is configured to execute a branch of the program according to the branch instruction.

4. The method for executing the program using the processor according to claim 1, wherein the instruction is included in a sequence of instructions received at the order-based reservation station in a program order; and wherein the order-based dispatch policy includes:
determining that a first segment of the plurality of segments is empty;
writing a first portion of the sequence of instructions to the first segment according to the program order, the first portion filling the first segment;
determining that a second segment of the plurality of segments is empty; and
writing a second portion of the sequence of instructions to the second segment according to the program order, the first segment and the second segment including the sequence of instructions in the program order.

5. The method for executing the program with the processor according to claim 4, wherein the order-based pick policy includes:
identifying an oldest segment of the plurality of segments;
identifying an oldest-ready instruction of the oldest segment; and
issuing the oldest-ready instruction of the oldest segment to the execution unit.

6. The method for executing the program with the processor according to claim 4, wherein the order-based pick policy includes:
identifying an oldest segment of the plurality of segments;
determining that the oldest segment has no instruction ready to be picked;
waiting for a period;
identifying an oldest-ready instruction of the oldest segment after the period; and
issuing the oldest-ready instruction to the execution unit.

7. The method for executing the program with the processor according to claim 6, wherein waiting for the period includes:
identifying a next-oldest segment of the plurality of segments;
identifying an oldest-ready instruction of the next-oldest segment; and
issuing the oldest-ready instruction of the next-oldest segment to the execution unit.

8. The method for executing the program with the processor according to claim 1, wherein the instruction is a first instruction, the type is a first type, the plurality of segments is a first plurality of segments, the execution unit is a first execution unit, and wherein the method further comprises:
receiving a second instruction from the program;
decoding the second instruction to determine a second type of the second instruction;
determining that the second type is not sensitive to the order of execution;
allocating the second instruction to a capacity-based reservation station of the processor, the capacity-based reservation station having a second plurality of segments;
dispatching the second instruction to a segment of the second plurality of segments according to a capacity-based dispatch policy of the capacity-based reservation station;
issuing the second instruction to a second execution unit coupled to the capacity-based reservation station according to a capacity-based pick policy of the capacity-based reservation station; and
executing the second instruction using the second execution unit.

9. The method according to claim 8, wherein:
the second type is an integer instruction or a floating-point instruction; and
the second execution unit is an arithmetic logic unit (ALU).

10. The method for executing the program with the processor according to claim 8, wherein the second instruction is included in a sequence of instructions received at the capacity-based reservation station; and wherein the capacity-based dispatch policy includes:
addressing each segment of the plurality of segments according to a segment-by-segment rotation through the plurality of segments; and
writing instructions of the sequence of instructions one-by-one to each segment being addressed that has a vacancy.

11. The method for executing the program with the processor according to claim 8, wherein the capacity-based pick policy includes:
issuing an oldest-ready instruction from each segment having at least one instruction ready to be picked in a segment-by-segment rotation through the plurality of segments.

12. A processor comprising:
a decode module configured to receive instructions of a program in a program order and determine respective types of the instructions; and
an allocation module configured to allocate a first portion of the instructions, which are a first type, to an order-based reservation station and allocate a second portion of the instructions, which are a second type, to a capacity-based reservation station, wherein:
the order-based reservation station is configured to store the first portion of the instructions in segments of the order-based reservation station according to an order-based dispatch policy, which preserves the program order of the first portion of the instructions; and
the capacity-based reservation station is configured to store the second portion of the instructions in segments of the capacity-based reservation station according to a capacity-based dispatch policy, which does not preserve the program order of the second portion of the instructions.

13. The processor according to claim 12, wherein:
the order-based reservation station is further configured to issue the first portion of the instructions stored in the segments of the order-based reservation station to a first execution unit according to an order-based pick policy; and
the capacity-based reservation station is configured to issue the second portion of the instructions stored in the segments of the capacity-based reservation station to a second execution unit according to a capacity-based pick.

14. The processor according to claim 13, wherein:
the first type is a memory instruction; and
the first execution unit is configured to access a memory according to the memory instruction.

15. The processor according to claim 13, wherein:
the first type is a branch instruction; and
the first execution unit is configured to execute a branch of the program according to the branch instruction.

16. The processor according to claim 13, wherein:
the second type is an integer instruction or a floating-point instructions; and
the second execution unit is an arithmetic logic unit (ALU).

17. The processor according to claim 13, further comprising:
a reorder module configured to reorder results of instructions after the instructions have been executed by the first execution unit and the second execution unit.

18. A processor, comprising:
an order-based reservation station configured to receive instructions of a first type from a program, the first type being sensitive to an order of execution, the order-based reservation station including:
a first dispatch module configured to store instructions in segments of the order-based reservation station according to an order-based dispatch policy so that the segments of the order-based reservation station receive instructions based on a program order of the instructions; and
a capacity-based reservation station configured to receive instructions of a second type from the program, the second type being sensitive to a capacity of segments of the capacity-based reservation station, the capacity-based reservation station including:
a second dispatch module configured to store instructions in segments of the capacity-based reservation station according to a capacity-based dispatch policy so that the segments of the capacity-based reservation station receive instructions based on a segment vacancy regardless of the program order of the instructions.

19. The processor according to claim 18, wherein:
the first type is a memory instruction; and
the second type is an integer instruction or a floating-point instruction.

20. The processor according to claim 18, wherein:
the order-based reservation station further includes:
a first pick module configured to issue instructions from the segments of the order-based reservation station to a first execution unit according to an order-based pick policy so that all instructions stored in a segment of the order-based reservation station are issued before the segment of the order-based reservation station receives new instructions; and
the capacity-based reservation station further includes:
a second pick module configured to issue instructions from the segments of the capacity-based reservation station to a second execution unit according to a capacity-based pick policy so that instructions are issued from segments regardless of the program order of the instructions.
